(19) United States
(12) Patent Application Publication
(10) Pub. No.: US 2010/0161414 A1
(43) Pub. Date: Jun. 24, 2010

(54) SYSTEM AND METHOD FOR ADVERTISING USING CLASSIFICATION INFORMATION

(75) Inventors: Jason Dean Ragsdale, Richardson, TX (US); Alex Khanin, Richardson, TX (US); Robert Ames, Irving, TX (US); Abel I. Rios, McKinney, TX (US); Thomas Falgout, Plano, TX (US); John Todd, Coppell, TX (US); Joey Kessler, Wylie, TX (US)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc., Sunnyvale, CA (US)

(21) Appl. No.: 12/339,124

(22) Filed: Dec. 19, 2008

(51) Int. Cl. G06Q 30/00; G06Q 90/00

(52) U.S. Cl. 705/14.49

(57) ABSTRACT

A system and method for providing advertisements via one or more computer systems is provided. According to one embodiment, a method for displaying advertisements is provided that includes acts of associating classification information, such as tags, with an advertisement, receiving a request to present the content classified by the classification information and providing the at least one advertisement in association with the content. According to another embodiment, a system for displaying advertisements is provided that includes a controller configured to associate classification information, such as tags, with an advertisement, receive a request to present the content classified by the classification information and provide the at least one advertisement in association with the content.

### BACKGROUND

1. Field of the Invention

At least one embodiment in accord with the present invention relates generally to systems and methods for advertising via the internet, and more specifically, to methods and systems for placing advertisements using information created to classify content.

2. Discussion of Related Art

There are a number of systems and methods that enable advertisers to present advertisements to viewers who are likely to find the advertisements relevant to their interests. For instance, internet websites that provide content regarding particular topics often sell screen real estate to advertisers of products and services related to these topics. In addition, the internet hosts several search engines that allow advertisers to present advertisements based on queries entered by users.

More particularly, some search engines, such as the YAHOO! brand search engine, provide an advertiser with the ability to trigger display of advertisements when on one or more keywords included in a query suggest the user may find an advertisement relevant. Under this system, advertisers select one or more keywords that, when entered by a user, may cause the search engine to display the advertiser's advertisement. These advertisements may include a variety of information, including one or more links to the advertiser's website or additional product or service information.

### SUMMARY OF THE INVENTION

Some aspects in accord with the present invention manifest an appreciation that classification information, i.e. information used to summarize or organize other information, provides a highly accurate indication of the relevance of particular advertisements to viewers of the classified information. Thus, in at least one embodiment, a system has facilities for advertisers to present advertisements while content, or portions of content, that are associated with particular classification information are being viewed. In this way, the system provides advertisers with the ability to increase the relevancy of their advertisements.

Other aspects manifest an appreciation that presenting advertisements for products or services along with the classification information is a valuable marketing tool. Thus, in some embodiments, a system includes facilities for advertisers to present advertisements in association with the presentation of classification information. For example, in one embodiment, a computer implemented process coordinates the presentation of classified content, classification information classifying the content and an advertisement associated with the classification information. Using this technique, the system provides advertisers with the ability to build associations between classification information and their products or services in the minds of consumers.

According to one aspect, a computer implemented method for providing at least one advertisement is provided. The method includes acts of associating classification information with the at least one advertisement, the classification information classifying content other than the at least one advertisement, receiving a request to present the content and presenting the at least one advertisement in association with the content. In one embodiment, the act of associating classification information with the at least one advertisement includes an act of associating at least one tag with the at least one advertisement. According to another embodiment, the act of associating classification information with the at least one advertisement includes an act of associating classification information that classifies a portion of the content with the at least one advertisement.

In another embodiment, the act of presenting the at least one advertisement includes an act of presenting the at least one advertisement in association with the classified portion of the content. Furthermore, according to an embodiment, the act of presenting the at least one advertisement in association with the classified portion of the content includes an act of presenting an advertisement including an image and a hyperlink in association with a portion of multi-media content. In an additional embodiment, the act of presenting the at least one advertisement in association with the classified portion of the content includes an act of presenting an advertisement including a multi-media presentation in association with a portion of image content.

Moreover, in one embodiment, the act of presenting the at least one advertisement includes an act of presenting the classification information. In addition, in one embodiment,

According to another embodiment, the method includes an act of receiving the content from a remote system. Additionally, according to one embodiment, the method includes an act of providing automation configured to present the at least one advertisement.

According to another aspect, a system for providing at least one advertisement is provided. The system includes a network interface, a storage medium, and a controller coupled to the network interface and the storage medium and configured to associate classification information with the at least one advertisement, the classification information classifying at least one portion of content, the content being content other than the at least one advertisement, receive, via the network interface, a request to present the content and provide, via the network interface, the at least one advertisement in association with the content.

In one embodiment, the classification information includes at least one tag. According to another embodiment, the controller is further configured to provide, via the network interface, the at least one advertisement in association with the at least one portion of content. Additionally, in one embodiment, the controller is further configured to receive, via the network interface, classification information from a remote system, and store the classification information on the storage medium. Furthermore, in an embodiment, the controller is further configured to provide, via the network interface, automation configured to present the at least one advertisement. Moreover, in an embodiment, the controller is further configured to receive, via the network interface, the content from a remote system.

According to another aspect, a computer readable medium storing computer readable instructions that, when executed by at least one controller, instruct the at least one controller to perform a method is provided. The method includes acts of associating classification information with the at least one advertisement, the classification information classifying content other than the at least one advertisement, receiving a request to present the content and presenting the at least one advertisement in association with the content. According to another embodiment, the instructions further instruct the at least one controller to associate at least one tag with the at least one advertisement. In addition, according to an embodiment, the instructions further instruct the at least one controller to associate classification information that classifies a portion of the content with the at least one advertisement. Furthermore, in one embodiment, the instructions further instruct the at least one controller to receive classification information from a remote system and to store the classification information on a storage medium. Moreover, according to an embodiment, the instruction further instruct the at least one controller to provide, via the network interface, automation configured to present the at least one advertisement. In an additional embodiment, the instruction further instruct the at least one controller to receive, via the network interface, the content from a remote system.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 illustrates an example computer system upon which various aspects in accord with the present invention may be implemented;

FIG. 2 depicts an example advertisement system in the context of a distributed system according to an embodiment;

FIG. 3 shows an example physical and logical diagram of an advertisement system according to an embodiment;

FIG. 4 presents an example process for providing an advertisement according to an embodiment;

FIG. 5 illustrates an example process for associating an advertisement with classification information according to an embodiment;

FIG. 6 depicts an example process for indicating the advertisement during review of content according to an embodiment; and

FIG. 7 shows an example process for presenting an advertisement according to an embodiment.

### DETAILED DESCRIPTION

At least one embodiment in accord with the present invention relates to a system with facilities, i.e. executable code and data structures, configured to place advertisements in relation to content based on information classifying the content. According to this embodiment, the system includes facilities that allow an advertiser, who has purchased one or more associations with the classification information, to associate an advertisement with classification information. Further, according to this embodiment, the system includes facilities for presenting the advertisement along with content classified by the classification information.

The aspects disclosed herein, which are in accord with the present invention, are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

For example, according to various embodiments of the present invention, a computer system is configured to perform any of the functions described herein, including but not limited to, associating advertisements with classification information. However, such a system may also perform other functions, such as providing a user interface through which advertisers may purchases associations between their advertisements and selected classification information. Moreover, the systems described herein may be configured to include or exclude any of the functions discussed herein. Thus the invention is not limited to a specific function or set of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

### Computer System

Various aspects and functions described herein in accord with the present invention may be implemented as hardware or software on one or more computer systems. There are many examples of computer systems currently in use. Some examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system elements and components using a variety of hardware and software configurations, and the invention is not limited to any particular distributed architecture, network, or communication protocol.

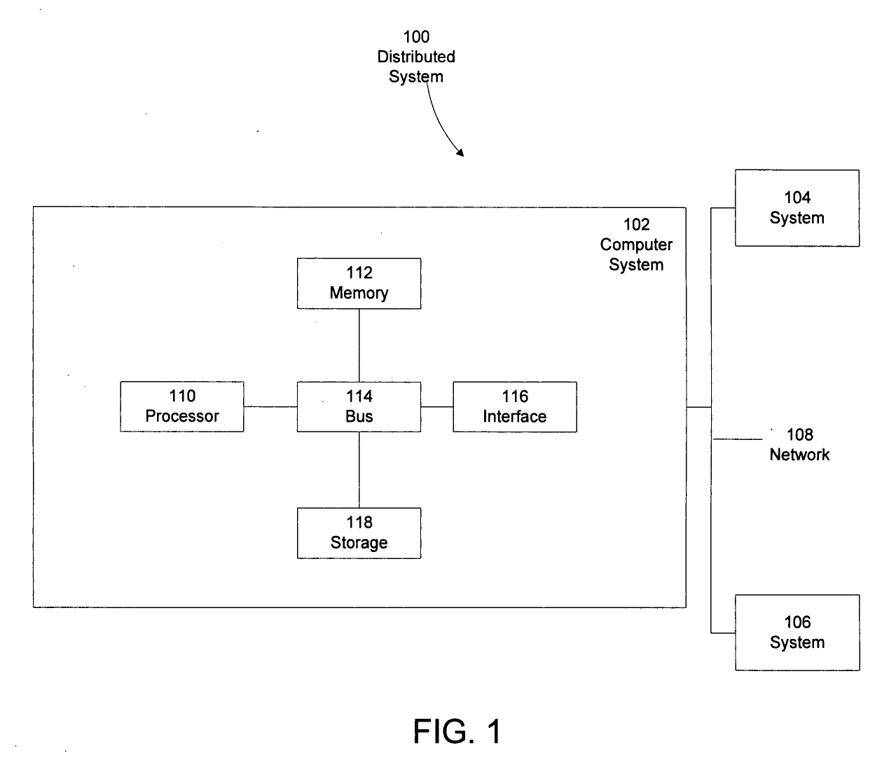

FIG. 1 shows a block diagram of a distributed computer system 100, in which various aspects and functions in accord with the present invention may be practiced. The distributed computer system 100 may include one more computer systems. For example, as illustrated, the distributed computer system 100 includes three computer systems 102, 104 and 106. As shown, the computer systems 102, 104 and 106 are interconnected by, and may exchange data through, a communication network 108. The network 108 may include any communication network through which computer systems may exchange data. To exchange data via the network 108, the computer systems 102, 104 and 106 and the network 108 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA IIOP, RMI, DCOM and Web Services. To ensure data transfer is secure, the computer systems 102, 104 and 106 may transmit data via the network 108 using a variety of security measures including TSL, SSL or VPN, among other security techniques. While the distributed computer system 100 illustrates three networked computer systems, the distributed computer system 100 may include any number of computer systems, networked using any medium and communication protocol.

Various aspects and functions in accord with the present invention may be implemented as specialized hardware or software executing in one or more computer systems including a computer system 102 shown in FIG. 1. As depicted, the computer system 102 includes a processor 110, a memory 112, a bus 114, an interface 116 and a storage system 118. The processor 110, which may include one or more microprocessors or other types of controllers, may perform a series of instructions that result in manipulated data. The processor 110 may be a commercially available processor such as an Intel Pentium, Motorola PowerPC, SGI MIPS, Sun UltraSPARC, or Hewlett-Packard PA-RISC processor, but may be any type of processor or controller as many other processors and controllers are available. The processor 110 is connected to other system elements, including a memory 112, by the bus 114.

The memory 112 may be used for storing programs and data during operation of the computer system 102. Thus, the memory 112 may be a relatively high performance, volatile, random access memory such as a dynamic random access memory (DRAM) or static memory (SRAM). However, the memory 112 may include any device for storing data, such as a disk drive or other non-volatile storage device. Various embodiments in accord with the present invention may organize the memory 112 into particularized and, in some cases, unique structures to perform the aspects and functions disclosed herein.

Components of the computer system 102 may be coupled by an interconnection element such as the bus 114. The bus 114 may include one or more physical busses (for example, busses between components that are integrated within a same machine), but may include any communication coupling between system elements including specialized or standard computing bus technologies such as IDE, SCSI, PCI and InfiniBand. Thus, the bus 114 enables communications (for example, data and instructions) to be exchanged between system components of the computer system 102.

The computer system 102 also includes one or more interface devices 116 such as input devices, output devices and combination input/output devices. The interface devices 116 may receive input or provide output. More particularly, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 116 allow the computer system 102 to exchange information and communicate with external entities, such as users and other systems.

The storage system 118 may include a computer readable and writeable nonvolatile storage medium in which instructions are stored that define a program to be executed by the processor. The storage system 118 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. The medium may, for example, be optical disk, magnetic disk or flash memory, among others. In operation, the processor 110 or some other controller may cause data to be read from the nonvolatile recording medium into another memory, such as the memory 112, that allows for faster access to the information by the processor than does the storage medium included in the storage system 118. The memory may be located in the storage system 118 or in the memory 112, however, the processor 110 may manipulate the data within the memory 112, and then copy the data to the medium associated with the storage system 118 after processing is completed. A variety of components may manage data movement between the medium and integrated circuit memory element and the invention is not limited thereto. Further, the invention is not limited to a particular memory system or storage system.

Although the computer system 102 is shown by way of example as one type of computer system upon which various aspects and functions in accord with the present invention may be practiced, aspects of the invention are not limited to being implemented on the computer system as shown in FIG. 1. Various aspects and functions in accord with the present invention may be practiced on one or more computers having a different architectures or components than that shown in FIG. 1. For instance, the computer system 102 may include specially-programmed, special-purpose hardware, such as for example, an application-specific integrated circuit (ASIC) tailored to perform a particular operation disclosed herein. While another embodiment may perform the same function using several general-purpose computing devices running MAC OS System X with Motorola PowerPC processors and several specialized computing devices running proprietary hardware and operating systems.

The computer system 102 may include an operating system that manages at least a portion of the hardware elements included in computer system 102. A processor or controller, such as processor 110, may execute an operating system which may be, among others, a Windows-based operating system (for example, Windows NT, Windows 2000 (Windows ME), Windows XP, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, aspects in accord with the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various aspects and functions in accord with the present invention may be implemented in a non-programmed environment (for example, documents created in HTML, XML or other format that, when viewed in a window of a browser program, render aspects of a graphical-user interface or perform other functions). Further, various embodiments in accord with the present invention may be implemented as programmed or non-programmed elements, or any combination thereof. For example, a web page may be implemented using HTML while a data object called from within the web page may be written in C++. Thus, the invention is not limited to a specific programming language and any suitable programming language could also be used.

A computer system included within an embodiment may perform functions outside the scope of the invention. For instance, aspects of the system may be implemented using an existing commercial product, such as, for example, Database Management Systems such as SQL Server available from Microsoft of Seattle Wash., Oracle Database from Oracle of Redwood Shores, Calif., and MySQL from Sun Microsystems of Santa Clara, Calif. or integration software such as WebSphere middleware from IBM of Armonk, N.Y. However, a computer system running, for example, SQL Server may be able to support both aspects in accord with the present invention and databases for sundry applications not within the scope of the invention.

### Example System Architecture

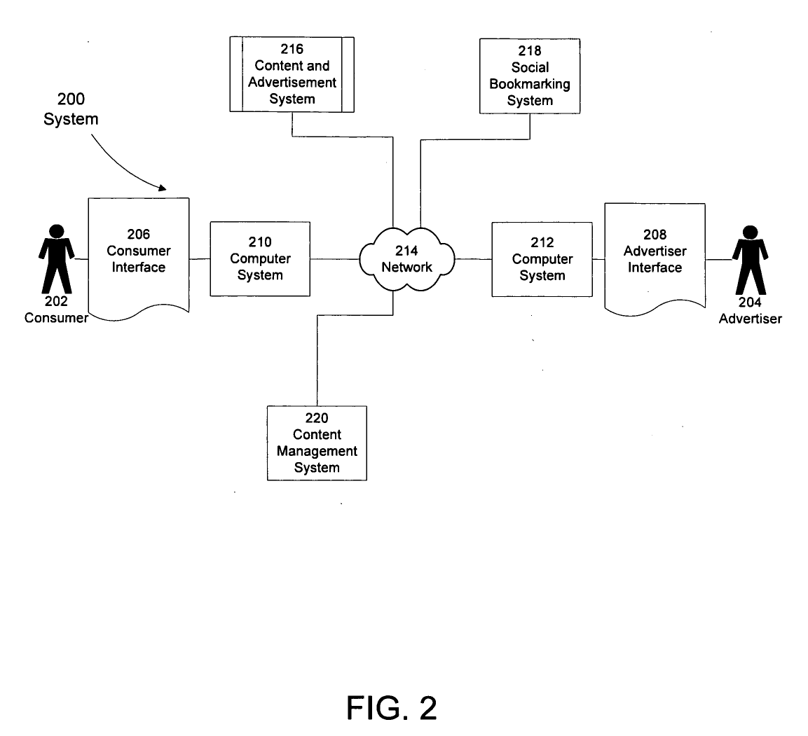

FIG. 2 presents a context diagram of a distributed system 200 specially configured to include an embodiment in accord of the present invention. Referring to FIG. 2, the system 200 includes a consumer 202, an advertiser 204, a consumer interface 206, an advertiser interface 208, computer systems 210 and 212, a communications network 214, a content and advertisement system 216, a social bookmarking system 218 and a content management system 220. In the embodiment shown, the interfaces 206 and 208 may be browser-based user interfaces served by the content and advertisement system 216 and rendered by the computer systems 210 and 212. In this illustration, the computer systems 210 and 212 are interconnected with one another and the content management system 220, the social bookmarking system 218 and the content and advertisement system 216 via the network 214. Additionally, as shown, the content and advertisement system 216 is connected to the social bookmarking system 218 through the network 214. The network 214 may include any communication network through which member computer systems may exchange data. For example, the network 214 may be a public network, such as the internet, and may include other public or private networks such as LANs, WANs, extranets and intranets.

The sundry computer systems shown in FIG. 2, which include the computer systems 210 and 212, the network 214, the content and advertisement system 216, the social bookmarking system 218 and the content management system 220, each may include one or more computer systems. As discussed above with regard to FIG. 1, computer systems may have one or more processors or controllers, memory and interface devices. The particular configuration of system 200 depicted in FIG. 2 is used for illustration purposes only and embodiments of the invention may be practiced in other contexts. Thus, the invention is not limited to a specific number of users or systems.

In various embodiments, the content and advertisement system 216 includes facilities configured to provide content, classification information and advertisements to users. In the illustrated embodiment, the content and advertisement system 216 can provide the consumer interface 206 to the consumer 202 and the advertiser interface 208 to the advertiser 204. In this embodiment, the consumer interface 206 includes facilities configured to allow the consumer 202 to search, select and review a variety of content. For example, as illustrated, the consumer interface 206 may serve content stored within the content and advertisement system 216 or content stored within the content management system 220.

According to another embodiment, the consumer interface 206 also includes facilities configured to present advertisements to the consumer 202. For example, the consumer interface 206 can present advertisements to the consumer 202 before, during or after the consumer 202 searches or selects content for review. Additionally, according to one embodiment, the consumer interface 202 includes facilities configured to enable a consumer to abbreviate or skip advertisements. In another embodiment, the consumer interface 206 may include media players in the form of one or more browser plug-ins that enable the consumer 202 to control content review.

With continued reference to the embodiment illustrated in FIG. 2, the advertiser interface 208 includes facilities configured to enable the advertiser 204 to affect how advertisements are provided to the consumer 202. For instance, in this and other embodiments, the advertiser interface 208 has facilities configured to help advertisers evaluate classification information, purchase associations between classification information and advertisements and provide advertisements to the content and advertisement system 216. Thus embodiments including the content and advertisement system 216 may allow both advertisers and consumers to benefit from an exchange of mutually relevant information.

In some embodiments, the content and advertisement system 216 may enable users to classify content using a variety of techniques and classification information. For example, in depicted embodiment, the consumer interface 206 includes facilities configured to allow a user to establish associations between content and classification information by tagging the content with symbols, such as icons or keywords. Moreover, some embodiments include facilities configured to establish associations between elements of classification information. For example, in one embodiment, users can associate tags with other tags in an organizational structure, such as a hierarchy. Thus embodiments including the content and advertisement system 216 may allow consumers of content to develop precise and accurate classification information that may be used by advertisers to increase advertisement relevance.

In other embodiments, the content and advertisement system 216 may exchange classification information with the social bookmarking system 218 via the network 214. For example, in one embodiment, the content and advertisement system 216 may expose a system interface to one or more systems, such as the DELICIOUS brand social bookmarking system. Thus embodiments including the content and advertisement system 216 may leverage existing classification information from gathered from other systems.

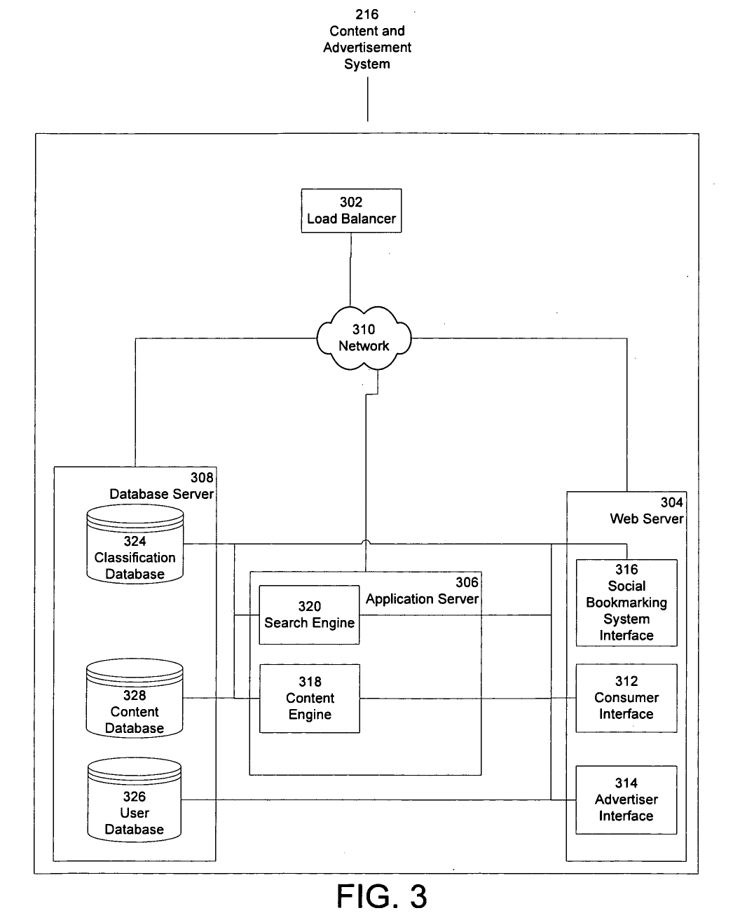

FIG. 3 provides a more detailed illustration of a particular physical and logical configuration of the content and advertisement system 216 as a distributed system. The system structure and content discussed below are for exemplary purposes only and are not intended to limit the invention to the specific structure shown in FIG. 3. As will be apparent to one of ordinary skill in the art, many variant system structures can be architected without deviating from the scope of the present invention. The particular arrangement presented in FIG. 3 was chosen to promote clarity.

In the embodiment illustrated in FIG. 3, the content and advertisement system 216 includes five primary physical elements: a load balancer 302, a web server 304, an application server 306, a database server 308 and a network 310. Each of these physical elements may include one or more computer systems as discussed with reference to FIG. 1 above. Further, in the illustrated embodiment, the web server 304 includes three logical elements: a consumer interface 312, an advertiser interface 314 and a social bookmarking system interface 316. The application server 306 includes two logical elements: a content engine 318 and a search engine 320. The database server 308 includes three logical elements: a classification database 324, a user database 326 and a content database 328.

In the depicted embodiment, the load balancer 302 provides load balancing services to the other elements of the content and advertisement system 216. The network 310 may include any communication network through which member computer systems may exchange data. The web server 304, the application server 306 and the database server 308 may be, for example, one or more computer systems as described above with regard to FIG. 1. For a high volume website, web server 304, application server 306 and database server 308 may include multiple computer systems, but embodiments may include any number of computer systems. Web server 304 may serve content using any suitable standard or protocol including, among others, HTTP, HTML, DHTML, XML and PHP.

In the embodiment illustrated in FIG. 3, the consumer interface 312 includes facilities configured to exchange (i.e. receive or provide) classification information, query information and content with a variety of external entities. Also, in this embodiment, the consumer interface 312 can exchange query information with the search engine 320, content information with the content engine 318 and classification information with the classification database 324. As illustrated, the advertiser interface 314 has facilities configured to exchange user, classification and content information with a variety of external entities. Additionally, in this embodiment, the advertiser interface 314 can exchange query information with the search engine 320, user information with the user database 326 and classification information with the classification information database 324. Furthermore, as depicted, the social bookmarking system interface 316 has facilities configured to exchange classification information with a variety of external entities. In addition, in this embodiment, the social bookmarking system interface 316 can exchange classification information with the classification database 324. As shown, the search engine 320 can exchange classification information with the classification database 324 and content information with the content database 328. Additionally, the content engine 318 can exchange classification information with classification database 324 and content information with content database 328 and a variety of external entities.

Information may flow between the elements, components and subsystems described herein using any technique. Such techniques include, for example, passing the information over the network via TCP/IP, passing the information between modules in memory and passing the information by writing to a file, database, or some other non-volatile storage device. In addition, pointers or other references to information may be transmitted and received in place of, or in addition to, copies of the information. Conversely, the information may be exchanged in place of, or in addition to, pointers or other references to the information. Other techniques and protocols for communicating information may be used without departing from the scope of the invention.

With continued reference to FIG. 3, the classification database 324 includes structures configured to store classification information classifying content included in the content database 328, or content stored elsewhere. In some embodiments, the classification database 328 includes a location identifier, such as a pointer or other reference, for the classified content. According to other embodiments, the classification database 328 also includes any data used to organize and categorize content. For example, in one embodiment, the classification information includes keyword tags. In another embodiment, the classification information includes other symbols from which meaning may be derived, such as images or icons.

According to various embodiments, the classification database 324 can include one or more advertisements and references to advertisements that are associated with the classification information. According to some embodiments, the advertisements may include any information that is conveyable via a computer system. Examples of advertisements included, among others, Uniform Resource Locators that identify websites, images, and text. In at least one embodiment, advertisements may also include automation, such as an ActiveX control or JAVA applet, that is downloaded prior to presentation of the advertisement. In at least one embodiment, the references to advertisements include pointers to the storage location of the advertisements.

In other embodiments, the classification database 324 can include metrics that indicate the desirability of classification information to an advertiser. For example, in one embodiment, the classification database 324 can store an indication of the amount of content that is classified by particular elements of classification information. In a similar embodiment, the classification database 324 can store an indication of the number of times particular tags have been used to search for content to review. As is discussed further below, in certain embodiments, the advertiser interface 314 can use this information to aid an advertiser in making purchasing decisions.

Returning to the embodiment shown in FIG. 3, the content database 328 includes structures configured to store content, references to content and other information describing content. Like advertisements, the content stored in the content database 328 may include any information conveyable via a computer system. Thus, content may be, among other information, still images, movies, audio and text. In one embodiment the content stored in the content database 328 includes advertisements. In at least one embodiment, the references to the content include pointers to content that is stored remotely from the content and advertisement system 216.

In the depicted embodiment, the user database 326 includes structures configured to store user information. This user account information may include any information required to setup, maintain and remove user accounts. Examples of user account information include, among other information, user identity, user authentication information, user method of payment information and user demographic information.

The databases 324, 326 and 328 may take the form of any logical construction capable of storing information on a computer readable medium including flat files, indexed files, hierarchical databases, relational databases or object oriented databases. The data may be modeled using unique and foreign key relationships and indexes. The unique and foreign key relationships and indexes may be established between the various fields and tables to ensure both data integrity and data interchange performance.

With continued reference to FIG. 3, the content engine 318 has facilities configured to retrieve content from a variety of sources and provide content to the consumer interface 312. For example, in one embodiment, the content engine 318 can retrieve content from the content database 328. In another embodiment, the content engine 318 can retrieve content from external content management systems, such as the content management system 220 discussed with regard to FIG. 2.

In another embodiment, the content engine 318 includes facilities configured to retrieve classification information, and associated advertisement information, from the classification database 324 and provide the classification information, along with any associated advertisement information, to the consumer interface 312. For example, the content engine 318 may stream media content and advertisements to the consumer interface 312. As is discussed further below, the consumer interface 312 can combine this advertisement and content information into an integrated presentation for an external entity.

In various embodiments, the search engine 320 has facilities configured to process query information received from the consumer interface 312 and response to the consumer interface 312 with query results. For example, according to one embodiment, the search engine 320 can receive a request from the consumer interface 312 to query content stored or referenced in the content database 328 using a set of keywords and can provide query results to the consumer interface 312 in response to the request. Similarly, in another embodiment, the search engine 320 can conduct a keyword query for classification information stored in the classification database 324 and can provide query results in response. In the depicted embodiment, these query results can be used by the consumer interface 312 to present content, within the context of the classification information, to a user.

In other embodiments, the search engine 320 includes facilities configured to process query information received from the advertiser interface 314 and response to the advertiser interface 314 with query results. For example, according to one embodiment, the search engine 320 can receive a request from the advertiser interface 314 to query classification information stored in the classification database 324 using a set of keywords and can provide query results to the advertiser interface 314 in response to the request. These results may include matching classification information and metrics describing the classification information as discussed above with reference to the classification database 324. In at least one other embodiment, the search engine can interrogate the classification database 324 to find associations between advertisements and classification information using the user that established the association.

With reference to the embodiments shown in FIG. 3, the consumer interface 312 may include facilities configured to provide a variety of graphical user interface (GUI) metaphors designed to allow a user to search for content, navigate search results, select content to review, review content and classify content using classification information. For example, in some embodiments, the consumer interface 312 may include GUI elements to enable a user to enter one or more keyword queries that are collaboratively processed with the search engine 320. In one embodiment, these GUI elements may include a text box and a query actuation element, such as a button. In other embodiments, the consumer interface 312 may present GUI elements that allow a user to browse an organization of tags to search for content to review. In this embodiment, these GUI elements may include an interactive density map or explorer-type tree navigator. According to various embodiments, these GUI elements and metaphors may also be used to browse search results generated using other GUI metaphors. In at least one embodiment, the GUI metaphor used is configurable by each user and may include a blend of other metaphors and elements, based on the preferences of the user.

According to another embodiment, the consumer interface 312 has facilities configured to enable a user to select and review content received via the content engine 318. For example, in one embodiment, a user may select content to review by clicking a link to the content that is contained in search results that are displayed in the consumer interface 312. In this embodiment, the consumer interface 312 can respond to the selection of content by presenting the selected content via the consumer interface 312. In some embodiments, the consumer interface 312 may include a conventional media player for to support presentation of the selected content, although this is not a requirement. As discussed above with reference to FIG. 2, the reviewable content may be stored locally to the content and advertising system 216, for example in the content database 328, or may be stored remotely in another content management system, such as the content management system 220.

In another embodiment, the consumer interface 312 includes facilities configured to present advertisements in association with the content. For example, in one embodiment, the consumer interface 312 can present advertisements while the user browses an organization of classification information. More specifically, the consumer interface 312 can present advertisements in response to the user selecting a particular tag while browsing an organization of tags.

In other embodiments, the consumer interface 312 can present advertisements upon the user selecting content for review. For example, in one embodiment, the consumer interface 312 has facilities configured to display advertisements associated with classification information when content classified by the classification information is selected by a user. In another embodiment, the consumer interface 312 can present these advertisements upon completion of the presentation of the selected content.

In still another embodiment, the consumer interface 312 can present advertisements during the presentation of a particular portion of content, i.e. the portion of the content that is classified by the classification information. For example, if the content is an image that includes a region that is classified as pertaining to Ireland, the consumer interface 312 can, in response to a user zooming into the region, display an advertisement for a Dublin hotel that has purchased an association between the advertisement and the classification information that classifies the region. In another example, if the content is a movie that depicts a character eating corn chips and that portion of the movie is tagged with a keyword of “corn chips,” the consumer interface 312 can, during the playback of that portion, display a link to a website of the corn chip marketer that has purchased an association between its advertisement and the “corn chips” tag.

In various embodiments, the consumer interface 312 includes facilities configured to enable a user to classify content with classification information and to store the classification information in the classification database 324. In some embodiments, the consumer interface 312 can classify content that is stored in the content database 328, or content that is stored elsewhere. Additionally, in some embodiments, the consumer interface 312 includes user interface elements that allow the user to select a portion of content and that allow the user to tag that portion of content with a symbol or keyword. In one embodiment, the consumer interface 312 includes a text box that allows the user to enter one or more keyword tags and a classification actuation element, such as a button, that when actuated tags the currently selected portion of content with any keyword tags currently displayed in the text box. In this embodiment, the portion of content that is currently being reviewed may be the portion that is tagged.

In other embodiments, the consumer interface 312 includes one or more controls that allow the user to expressly specify portions of content for tagging. For example, in one embodiment, the consumer interface 312 has facilities that enable a user to select a portion of an image for tagging by clicking and dragging a cursor element relative to the image to outline a region of the image. In another embodiment, the consumer interface 312 can allow a user can select a portion of a movie for tagging by specifying in drop-down boxes the start time and end time of the portion to be tagged. In this embodiment, the user may further define the portion of the movie to be tagged by clicking and dragging a cursor element to outline a region within the specified portion of the movie images.

In additional embodiments, the consumer interface 312 has facilities configured to enable a user to segment multi-media content into its constituent media components for purposes of classification. For example, in one embodiment, the consumer interface 312 can allow a user to tag a portion of a soundtrack of a movie without tagging other media components of the movie. In another embodiment, the consumer interface 312 can allow a user to tag the dialogue of a particular actor or a certain frequency range in the soundtrack. Thus, in summary, embodiments include facilities configured to generate precise and accurate classification information that may be of substantial value to potential advertisers.

With continued reference to the embodiment illustrated in FIG. 3, the advertiser interface 314 includes facilities configured to provide a variety of GUI metaphors designed to allow an advertiser to administer a user account. For example, in one embodiment, the advertiser interface 314 includes facilities to allow an advertiser to create, modify or delete user account information. In various embodiments, this user account information may include any of the information discussed above with regard to the user database 326.

In another embodiment, the advertiser interface 314 has facilities configured to allow a user to search and select classification information to associate with one or more advertisements. For example, in some embodiments, the advertiser interface 314 may include GUI elements to enable a user to enter one or more keyword queries that are collaboratively processed with the search engine 320. In one embodiment, these GUI elements may include a text box and a query actuation element, such as a button. In other embodiments, the advertiser interface 314 may present GUI elements that allow a user to browse an organization of tags to search for desirable classification information. In this embodiment, these GUI elements may include an interactive density map or explorer-type tree navigator. According to various embodiments, these GUI elements and metaphors may also be used to browse search results generated using other GUI metaphors. In at least one embodiment, the GUI metaphor used is configurable by each user and may include a blend of other metaphors and elements, based on the preferences of the user.

In various embodiments, the advertiser interface 314 includes facilities configured to provide an advertiser with information indicating a variety of characteristics of classification information that are stored in classification database 324. In some of these embodiments, the advertiser interface 314 can present a variety of metrics that indicate the desirability of classification information to the advertiser. For example, in one embodiment, the advertiser interface 314 can provide, while the advertiser is browsing classification information, an indication of the amount of content that is classified by particular elements of classification information. In a similar embodiment, the advertiser interface 314 can display an indication of the number of times particular tags have been used to search for content to review. In another embodiment, the advertiser interface 314 can display an estimate of the advertisement traffic generated by association with particular classification information. Thus, embodiments provide advertisers with pertinent information upon which to make decisions to purchase classification information associations for their advertisements.

In another embodiment, the advertiser interface 314 includes facilities configured to enable a user to specify advertisements to be associated with classification information. In this embodiment, the advertiser interface 314 can store the associations between the advertisements and the classification information in the classification database 324. Additionally, as discussed above with regard to the classification database 324 and according to various embodiments, these advertisements may include any information that is conveyable via a computer system. Thus, embodiments may include advertisements that include, among other content, executable and non-executable content. For example, in one embodiment, the advertiser interface 314 can accept advertisements that are browser plug-ins; while in another embodiment, the advertiser interface 314 can accept advertisements that are simple textual messages. In an additional embodiment, the advertiser interface 314 can accept advertisements that are hyperlinks to internet web pages.

In another embodiment, the advertiser interface 314 has facilities configured to allow a user to purchase associations between classification information and advertisements. For example, in one embodiment, the advertiser interface 314 provides user interface elements through which an advertiser may place a bid to have a particular advertisement presented in association with content or classification information, as discussed above with regard to the consumer interface 312. In this embodiment, the advertiser interface 314 includes selection elements, such as combo boxes, through which particular classification information and advertisements may be selected. Additionally, in this embodiment, the advertiser interface 314 has a text box, into which the bid may be placed, and a bid actuation element, such as a button, that when actuated, causes the bid currently displayed in the text box to be placed. In some embodiments, whether a particular advertisement is displayed when a particular instance of content or classification information is selected or reviewed may be determined as a function of the bid and the click through rate of the advertisement.

Returning to the embodiment of FIG. 3, the social bookmarking system interface 316 includes facilities configured to exchange classification information with a variety of external entities. In the depicted embodiment, the classification information can include information classifying content within the content database 328 or classifying content stored elsewhere. As shown, the social bookmarking system 316 can store this classification information in the classification database 324.

Each of the interfaces disclosed herein exchange information with various providers and consumers. These providers and consumers may include any external entity including, among other entities, users and systems. In the exemplary embodiment illustrated in FIG. 3, users may exchange information with the consumer interface 312 and advertiser interface 314. In an alternative embodiment, this information may be exchanged with other applications or storage media using system interfaces exposed by each of these elements. Each of the interfaces disclosed herein may both restrict input to a predefined set of values and validate any information entered prior to using the information or providing the information to other components. Additionally, each of the interfaces disclosed herein may validate the identity of an external entity prior to, or during, interaction with the external entity. These functions may prevent the introduction of erroneous data into the system or unauthorized access to the system.

### Advertisement Placement Processes

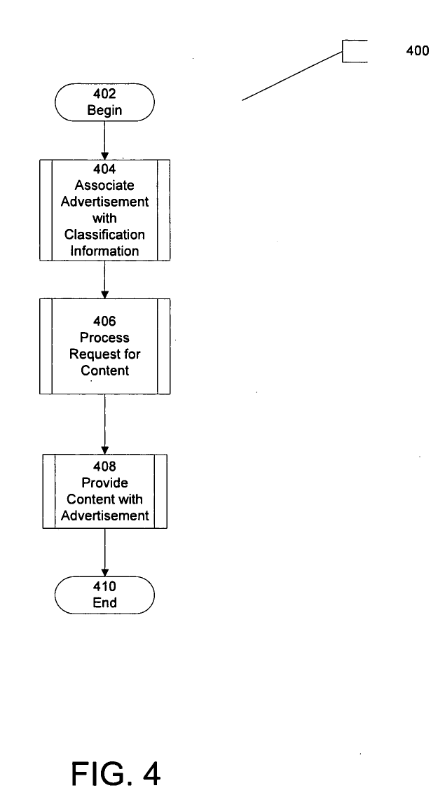

Various embodiments provide processes for placing advertisements with relevant content. FIG. 4 illustrates one such process 400 that includes acts of creating an association between an advertisement and classification information, processing a request for content and providing the advertisement in association with the content. Process 400 begins at 402.

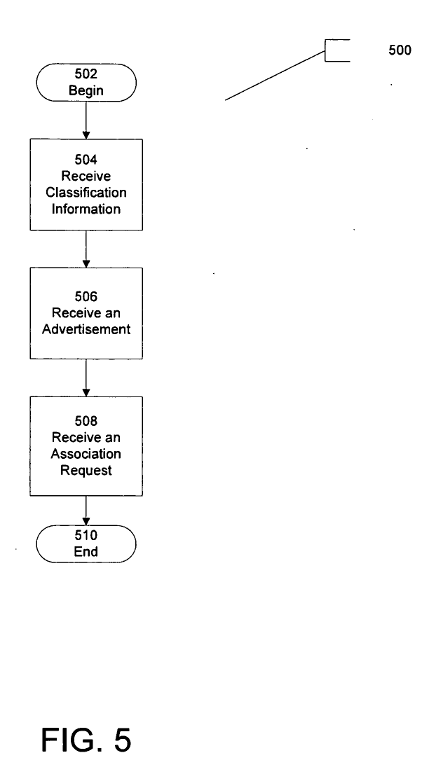

In act 404, an association between an advertisement and classification information is created. According various embodiments, a computer system may create an association between an advertisement and classification information that classifies content. Acts in accord with these embodiments are discussed below with reference to FIG. 5.

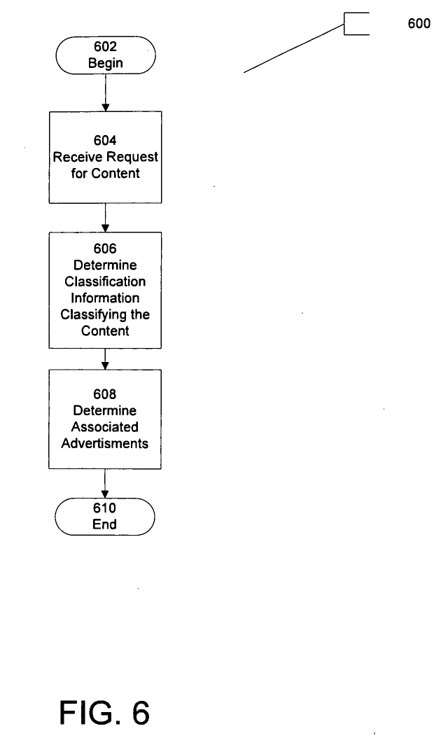

In act 406, a request for content is processed. According various embodiments, a computer system may process a request to provide content that is classified by classification information. Acts in accord with these embodiments are discussed below with reference to FIG. 6.

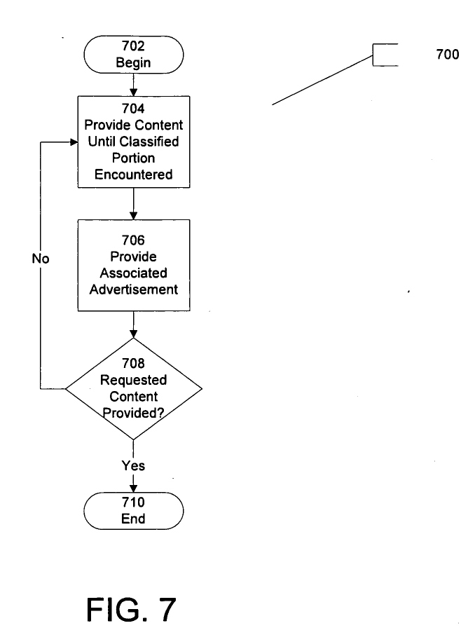

In act 408, content is provided in association with advertisements. According to some embodiments, content is provided along with advertisements that are associated with classification information that classifies the content. Acts in accord with these embodiments are discussed below with reference to FIG. 7.

Process 400 ends at 410. Thus, process 400 enables a computer system to increase the relevancy of advertisements by associating the advertisements with highly accurate, human generated classification information.

Various embodiments provide processes for a computer system to create an association between an advertisement and classification information. FIG. 5 illustrates one such process 500 that includes acts of receiving classification information, receiving an advertisement and receiving a request to create an association between the classification information and the advertisement. Process 500 begins at 502.

In act 504, a computer system receives classification information. According to one embodiment, the consumer interface 312 receives the classification information from a consumer reviewing content, as discussed above. In another embodiment, the social bookmarking interface 316 receives the classification information from an external system. In both of these embodiments, the referenced classification information is stored in the classification database 324. As discussed above, the classification information may classify any content, including content stored in the content database 328 or elsewhere.

In act 506, a computer system receives an advertisement. In one embodiment, this reference is received by the advertiser interface 314, as described above. According to another embodiment, the referenced advertisement is stored in the classification database 324. As discussed above, the advertisement may include any information conveyable via a computer system.

In act 508, a computer system receives a request to create an association between the referenced classification information and the referenced advertisement. In one embodiment, this association is created by the advertiser interface 314 when an advertiser purchases the association, as described above. According to this embodiment, the association is stored in the classification database 324.

Process 500 ends at 510.

Various embodiments provide processes for a computer system to process a request for content. FIG. 6 illustrates one such process 600 that includes acts of receiving a request for content, determining classification information classifying the content and determining advertisements associated with the classification information. Process 600 begins at 602.

In act 604, a computer system receives a request for content. In one embodiment, the request may be received by the consumer interface 312 and provided to the content engine 318, as discussed above. In this embodiment, the content may be stored in the content database 328 or elsewhere.

In act 606, a computer system determines the classification information classifying the content. As discussed above, in one embodiment, the classification database 324 stores classification information classifying the content. In this embodiment, the content engine 318 determines the classification information classifying the content with reference to the classification database 324.

In act 608, a computer system determines the advertisements associated with the classification content. In one embodiment, the classification database 324 stores associations between classification information and advertisements, as discussed above. In this embodiment, the content engine 318 determines the advertisements associated with the classification information with reference to the classification database 324.

Process 600 ends at 610.

Various embodiments provide processes for a computer system to provide content in association with advertisements. FIG. 7 illustrates one such process 700 that includes acts of providing content until a portion classified by classification information is encountered, providing an advertisement associated with the classification information and determining if all of the requested content has been provided. Process 700 begins at 702.

In act 704, a computer system provides content until a portion of the content that is classified by classification information is encountered. As discussed above, according to one embodiment, the content engine 318 receives the content from the content database 328, or elsewhere, and provides the content to the consumer interface 312. In this embodiment, the consumer interface 312 displays the content, as provided by the content engine 318, to a consumer.

In act 706, a computer system provides an advertisement that is associated with classification information encountered. According to one embodiment, the content engine 318 provides the advertisement from the classification database 324. In this embodiment, the consumer interface 312 displays the commercial in context with the content as provided by the content engine 318, to a consumer.

In act 708, a computer system determines if all of the requested content has been provided. If so, process 700 proceeds to act 710. If not, process 700 proceeds to act 704.

Process 700 ends at 710.

Each of process 400, 500, 600 and 700 depicts one particular sequence of acts in a particular embodiment. The acts included in each of these processes may be performed by, or using, one or more computer systems specially configured as discussed herein. Thus the acts may be conducted by external entities, such as users or separate computer systems, by internal elements of a system or by a combination of internal elements and external entities. Some acts are optional and, as such, may be omitted in accord with one or more embodiments. Additionally, the order of acts can be altered, or other acts can be added, without departing from the scope of the present invention. In at least some embodiments, the acts have direct, tangible and useful effects on one or more computer systems, such as storing data in a database or providing information to external entities.

While the bulk of this detailed description focuses on advertisers that purchase associations between content and advertisements, in some embodiments, the advertisers may associate advertisements with content without purchasing the association. In these embodiments, the advertiser may be associated with (for example, be employed by) the owner of the content and advertisement system 216. Further, in these and other embodiments, the advertisements may concern other offerings of the owner of the content and advertisement system 216.

For instance, in one embodiment, the classification information includes tags that represent geographic locations. In one particular example, these tags may be presented in association with content, such as a movie scene, that depicts the geographic locations represented by the tags. When this occurs, a consumer may, using the facilities described above, select the classification information and in response the system may directed the consumer to other content, such as an interactive map of the geographic location, that is provided by the owner of the content and advertisement system 216.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements.

Any embodiment disclosed herein may be combined with any other embodiment, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects disclosed herein. References to “or” may be construed as inclusive so that any terms described using “or” may indicate any of a single, more than one, and all of the described terms.

Where technical features in the drawings, detailed description or any claim are followed by references signs, the reference signs have been included for the sole purpose of increasing the intelligibility of the drawings, detailed description, and claims. Accordingly, neither the reference signs nor their absence have any limiting effect on the scope of any claim elements.

Having now described some illustrative aspects of the invention, it should be apparent to those skilled in the art that the foregoing is merely illustrative and not limiting, having been presented by way of example only. Similarly, aspects of the present invention may be used to achieve other objectives including allowing content and advertisement providers to provide free advertisements to particular entities, such as non-profit concerns. Numerous modifications and other illustrative embodiments are within the scope of one of ordinary skill in the art and are contemplated as falling within the scope of the invention. For example, while the bulk of the illustrations included tag classification information, other embodiments may use other sorts of classification information, such as logical locations within one or more directory structures. In particular, although many of the examples presented herein involve specific combinations of method acts or system elements, it should be understood that those acts and those elements may be combined in other ways to accomplish the same objectives.

What is claimed is:

1. A computer implemented method for providing at least one advertisement comprising:
associating classification information with the at least one advertisement, the classification information classifying content other than the at least one advertisement;
receiving a request to present the content; and
presenting the at least one advertisement in association with the content.

2. The method according to claim 1, wherein associating classification information with the at least one advertisement includes associating at least one tag with the at least one advertisement.

3. The method according to claim 1, wherein associating classification information with the at least one advertisement includes associating classification information that classifies a portion of the content with the at least one advertisement.

4. The method according to claim 3, wherein presenting the at least one advertisement includes presenting the at least one advertisement in association with the classified portion of the content.

5. The method according to claim 4, wherein presenting the at least one advertisement in association with the classified portion of the content includes presenting an advertisement including an image and a hyperlink in association with a portion of multi-media content.

6. The method according to claim 4, wherein presenting the at least one advertisement in association with the classified portion of the content includes presenting an advertisement including a multi-media presentation in association with a portion of image content.

7. The method according to claim 1, wherein presenting the at least one advertisement includes presenting the classification information.

8. The method according to claim 1, further comprising receiving the content from a remote system.

9. The method according to claim 1, further comprising providing automation configured to present the at least one advertisement.

10. A system for providing at least one advertisement comprising:
a network interface;
a storage medium; and
a controller coupled to the network interface and the storage medium and configured to:
associate classification information with the at least one advertisement, the classification information classifying at least one portion of content, the content being content other than the at least one advertisement;
receive, via the network interface, a request to present the content; and
provide, via the network interface, the at least one advertisement in association with the content.

10. (canceled)

11. The system according to claim 10, wherein the controller is further configured to provide, via the network interface, the at least one advertisement in association with the at least one portion of content.

12. The system according to claim 10, wherein the controller is further configured to:
receive, via the network interface, classification information from a remote system; and
store the classification information on the storage medium.

13. The system according to claim 10, wherein the controller is further configured to provide, via the network interface, automation configured to present the at least one advertisement.

14. The system according to claim 10, wherein the controller is further configured to receive, via the network interface, the content from a remote system.

15. A computer readable medium storing computer readable instructions that, when executed by at least one controller, instruct the at least one controller to perform a method comprising:
associating classification information with the at least one advertisement, the classification information classifying content other than the at least one advertisement;
receiving a request to present the content; and
presenting the at least one advertisement in association with the content.

16. The computer readable medium of claim 15, wherein the instructions further instruct the at least one controller to associate at least one tag with the at least one advertisement.

17. The computer readable medium of claim 15, wherein the instructions further instruct the at least one controller to associate classification information that classifies a portion of the content with the at least one advertisement.

18. The computer readable medium of claim 15, wherein the instructions further instruct the at least one controller to receive classification information from a remote system and to store the classification information on a storage medium.

19. The computer readable medium of claim 15, wherein the instructions further instruct the at least one controller to provide, via the network interface, automation configured to present the at least one advertisement.

20. The computer readable medium of claim 15, wherein the instructions further instruct the at least one controller to receive, via the network interface, the content from a remote system.
